(19) United States
(12) Patent Application Publication
(10) Pub. No.: US 2006/0171673 A1
(43) Pub. Date: Aug. 3, 2006

(54) Playback of video file in accordance with previously generated playback settings file

(76) Inventors: James R. Cole, Albany, OR (US); William J. Allen, Corvallis, OR (US); Robert M. Schneider, Corvallis, OR (US); Thomas J. Gilg, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/047,937

(22) Filed: Feb. 1, 2005

(51) Int. Cl. H04N 5/91

(52) U.S. Cl. 386/95

(57) ABSTRACT

A method retrieves a playback settings file for a video file. The playback settings file is previously generated based at least on analysis of the video file without alteration of the video file. The playback settings file contains information for playback of the video file other than information for decoding the video file. The method plays back the video file in accordance with the playback settings file.

### BACKGROUND

Whereas historically video, or moving pictures, was delivered in analog format, such as via videocassettes, more recently video is being delivered in digital format. Such digital formats include video files stored on digital versatile discs (DVD's), as well as video files downloaded from a video server over a network. Most consumers agree that digital video offers clearer pictures than analog video.

For digital video to be properly displayed on a display device, such as a projector, a projection system, a plasma screen, or a liquid-crystal display (LCD), it must be digitally processed. Typically, a playback device performs this processing. Playback devices include standalone devices, such as DVD players, set-top boxes, and satellite and cable TV boxes, as well as more general-purpose devices, such as home theater personal computers (HTPC's).

Most playback devices process digital video to be played back in real-time, performing a large number of processing tasks as the digital video is being streamed to a display device. As such, complex and expensive circuitry or software is usually built into such playback devices. To deliver playback devices at a certain price point, however, sometimes the circuitry or software is downgraded, with a resulting decrease in picture quality.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a diagram of a system in which a playback settings file for a video file is generated and used for real-time playback of the video file, according to an embodiment of the invention.

FIG. 2 is a diagram depicting how the playback settings file can include playback settings for the video file on a frame-by-frame basis, according to an embodiment of the invention.

FIG. 3 is a diagram depicting how the playback settings file can include playback settings for the video file on a group of frames-by-group of frames basis, according to an embodiment of the invention.

FIG. 4 is a diagram depicting how a playback device can retrieve a previously generated playback settings file for a video file from a server over a network, according to an embodiment of the invention.

FIG. 5 is a diagram depicting how a playback device may have already stored at a local storage device a previously generated playback settings file for a video file, according to an embodiment of the invention.

FIG. 6 is a flowchart of a method for using previously generated playback settings in playing back a video file for display, according to an embodiment of the invention.

FIG. 7 is a rudimentary block diagram of a playback device that employs previously generated playback settings when playing back a video file for display, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

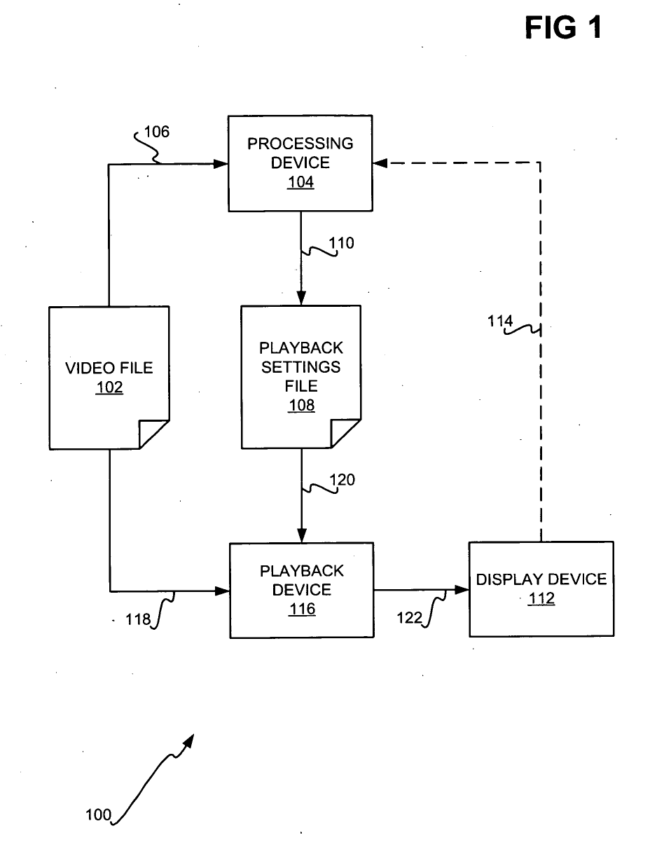

FIG. 1 shows a system 100, according to an embodiment of the invention. A video file 102 is first received by a processing device 104, as indicated by the arrow 106. The video file 102 is a moving pictures file that may or may not include audio information as well as video information. The video file 102 is in one embodiment digital video. The digital video may be formatted in accordance with the MPEG-2 format, as is commonly found on DVD's, the MPEG-4 format, the DivX format, or another type of digital video format. The video file 102 may be received by the processing device 104 on a physical computer-readable medium, such as a DVD, or may be received by the device 104 over a network via electronic transmission. The processing device 104 may be a general-purpose computing device, such as a desktop or laptop computer, for instance.

The processing device 104 generates optimal playback settings for playing back the video file 102, as the playback settings file 108, as indicated by the arrow 110. In one embodiment, the device 104 further generates these playback settings based on the particular type of display device 112 that may be used to play back the video file 102, and/or other parameters regarding the display device 112. The type of playback settings generated within the playback settings file 108 include information for playback of the video file 102 other than information for decoding the video file 102. Decoding the video file 102 refers to processing or decompressing the video file 102 to acquire the individual video frames that make up the video of the video file 102. For instance, digital video formatted in accordance with the MPEG-2, MPEG-4, and DivX formats have to be decoded to play back the video. The playback settings file 108 contains information for playback of the video file 102 other than information useful for decoding the video file 102.

The playback settings file 108 may, for example, contain other information that is useful for playback of the video file 102 after it is decoded into individual video frames. Such information can include deinterlacing settings, such as whether a particular one or more frames of the video file 102 after decoding should be deinterlaced in accordance with a movie mode, a video mode, a bob mode, a weave mode, an adaptive deinterlacing mode, and the like. Such information can further include whether and/or how various video noise reduction settings should be employed for a particular one or more of the decoded frames of the video file 102. Other information that can be included in the playback settings file 108 can include whether and/or how color adjustment settings, brightness, or black level, adjustment settings, contrast, or white level, adjustment settings, and scaling settings should be employed for a particular one or more of the decoded frames of the video file 102. Such information can be determined, for example, based on analysis of the video file 102 alone, and/or in conjunction with knowledge of the particular type of display device 112 on which the video file 102 is to be played back, or other parameters regarding the display device 112.

Generation of the playback settings file 108 does not result in alteration of the video file 102, can occur in non-real time, and is accomplished prior to the actual playback of the video file 102. Therefore, as much processing as is needed to generate the playback settings for a given one or more frames of the video file 102 can be used, since there are no real-time playback constraints on generating the playback settings. Furthermore, the playback settings of the file 108 may be optimally generated based on conducting more than one pass of the video file 102. That is, a first pass of the video file 102 may yield initial analyses that can be confirmed or modified in later passes of the video file 102 to result in the ultimate playback settings of the file 108. The generation process of the playback settings file 108 may be a user-interactive or a non-user-interactive process. For example, the user may provide guidance to the playback settings generation process, confirming that certain playback settings should be used, or modifying certain playback settings so that playback of the video file 102 results in optimal picture quality. It is noted that the user who provides this guidance may typically be a trained technician or other individual, as opposed to the end user who views the video file 102.

Once the playback settings file 108 has been generated, at a later point in time a playback device 116 receives the video file 102, as indicated by the arrow 118, and then retrieves the playback settings file 108 for the video file 102, as indicated by the arrow 120. The playback device 116 plays back the video file 102 on the display device 112 using the playback settings file 108, as indicated by the arrow 122. The playback device 116 may be a DVD player, a set-top box, a home theater personal computer (HTPC), a satellite or cable TV box, or another type of playback device. The display device 112 may be a projector, a projection system, a plasma display, a liquid-crystal display (LCD), or another type of display device. The playback device 116 may receive the video file 102 on a physical computer-readable medium, such as a DVD, or may receive the video file 102 via an electronic transmission over a network.

In one embodiment, the playback device 116 and the display device 112 may be the same device. For instance, the display device 112 may be the playback device 116 in the sense that the display device 112 uses the playback settings file 108 for optimal playback of the video file 102. In another embodiment, the playback device 116 and the processing device 104 may be the same device. For instance, the playback device 116 may be the processing device 104 in the sense that the playback device 116 first generates the playback settings file 108, and then later uses the playback settings file 108 that it previously generated when playing back the video file 102.

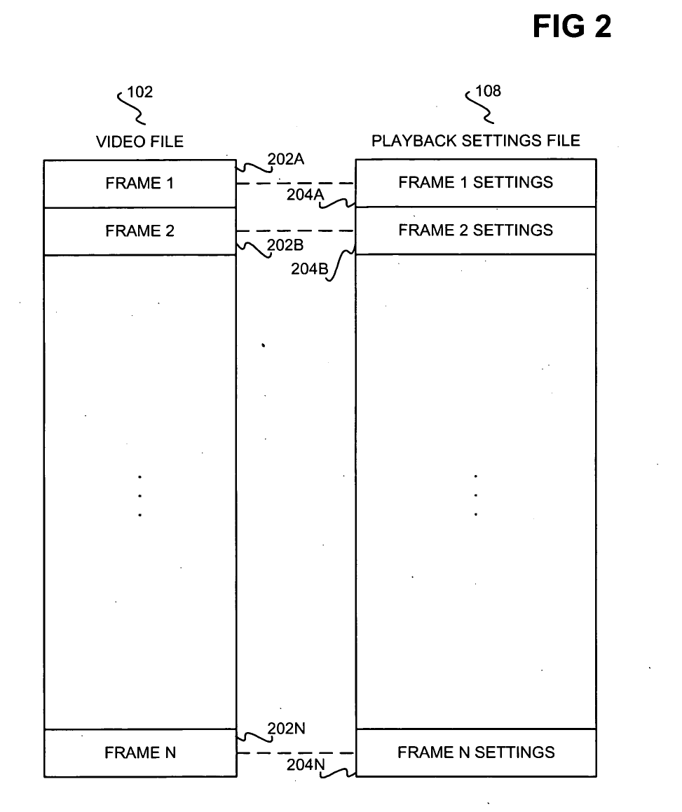

FIG. 2 shows how the playback settings file 108 can be used for playing back the video file 102 on a frame-by-frame basis, according to an embodiment of the invention. After decoding, the video file 102 includes a number of frames 202A, 202B, . . . , 202N, collectively referred to as the frames 202. The playback settings file 108 includes frame-by-frame playback settings 204A, 204B, . . . , 204N that correspond to the frames 202 and that are collectively referred to as the playback settings 204. After a particular one of the frames 202 has been decoded from the video file 102, the corresponding playback settings 204 for that frame are examined to determine how to optimally or other wise preferably playback that frame. For example, once the frame 202B has been decoded from the video file 102, the playback settings 204B of the playback settings file 108 are examined to determine how to optimally or other wise preferably playback the frame 202B. Such playback settings 204B may include information as to how to deinterlace the frame 202B, whether and how to adjust the color settings, video noise reduction settings, brightness settings, contrast settings, and the like for displaying the frame 202B, and so on.

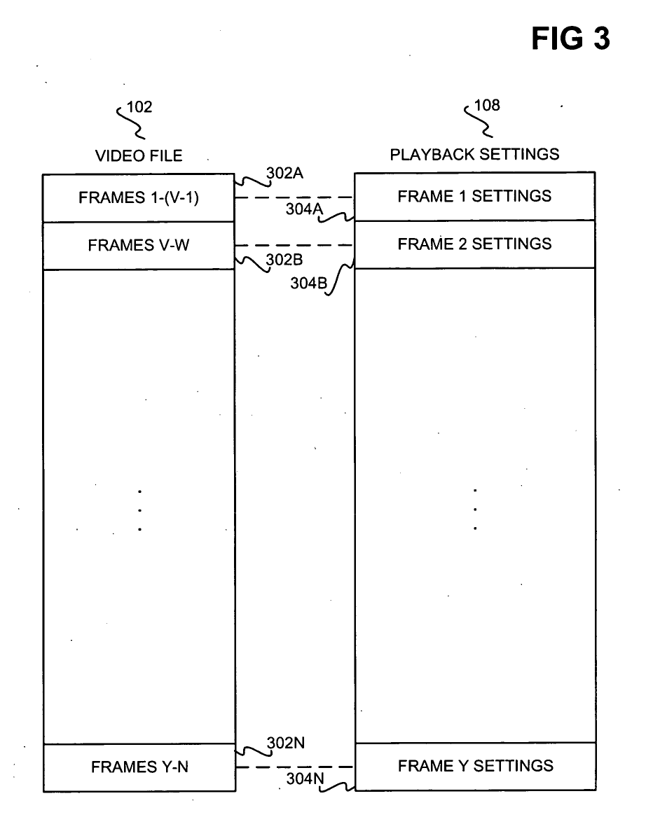

FIG. 3 shows how the playback settings file 108 can be used for playing back the video file 102 on a group of frames-by-group of frames basis, according to an embodiment of the invention. After decoding, the video file 102 includes a number of frame groups 302A, 302B, . . . , 302N, collectively referred to as the frame groups 302. For example, the frame group 302A may include frames 1 through V-1, the frame group 302B may include frames V through W. and the frame group 302N may include frames Y through N. The playback settings file 108 includes frame group-by-frame group playback settings 304A, 304B, . . . , 304N that each correspond to the first frame of one of the frame groups 302 and that are collectively referred to as the playback settings 304.

The settings for a given group of frames are used for playback of each of those frames until a frame is reached that has new settings. For example, the playback settings 304A specify that those playback settings are to be used beginning with frame 1 of the video file 102 after decoding, whereas the playback settings 304B specify that those playback settings are to be used beginning with frame V of the video file 102. Therefore, frames 1 through V-1, corresponding to the frames group 302A, are played back in accordance with the playback settings 304A, whereas the frames beginning with the frame V, corresponding to the frame group 302B, are played back in accordance with the playback settings 304B. The difference between the embodiment of FIG. 3 and the embodiment of FIG. 2 is thus that the FIG. 2 embodiment has playback settings for every frame of the decoded video file 102, whereas the FIG. 3 embodiment has playback settings for one or more groups of frames of the decoded video file 102.

With respect to the embodiments of both FIGS. 2 and 3, using the playback settings file 108 for playing back the video file 102 for display provides for less processing of the video file 102 having to be performed during playback of the video file 102. For example, rather than having to process the video file 102 during playback and in real-time to determine the settings with the playback settings file 108, the playback device 116 of FIG. 1 merely has to retrieve the settings from the file 108. As such, the playback device 116 may be able to have less processing power than would otherwise be required to determine the playback settings of the playback settings file 108 in real-time while playing back the video file 102. However, such a playback device 116 should still have sufficient processing power to be able to decode the video file 102 in real-time to realize the individual video frames of the video file 102 to which the settings of the playback settings file 108 correspond.

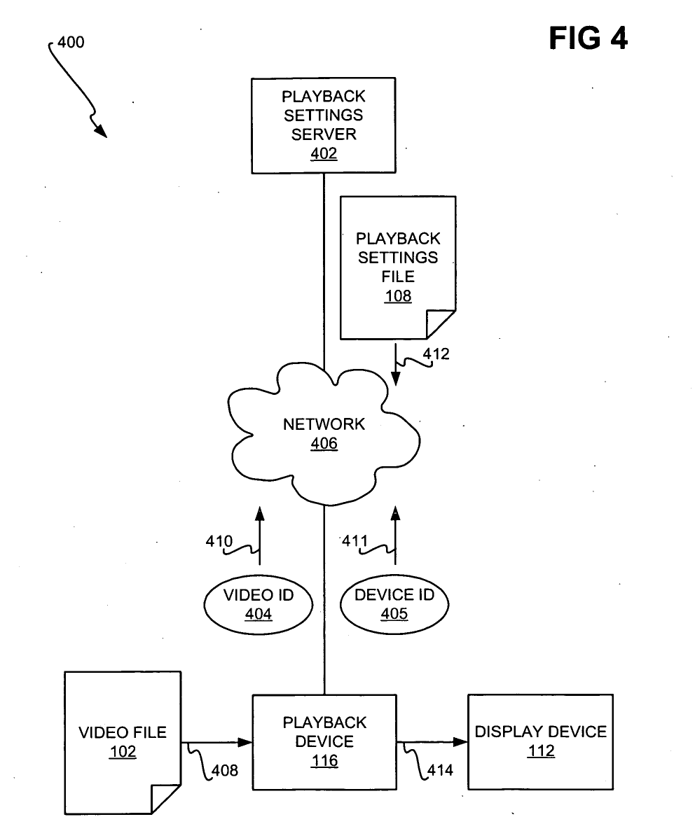

FIG. 4 shows a system 400 depicting the manner by which the playback device 116 is able to acquire the playback settings file 108 for a particular video file 102, according to an embodiment of the invention. The playback settings file 108 for the video file 102 is generated before playback of the video file 102 by the playback device 116, and is stored at a playback settings server 402. The playback device 116 and the playback settings server 402 are communicatively coupled to one another over a network 406. The network 406 may include one or more of a local-area network (LAN), a wide-area network (WAN), an intranet, an extranet, the Internet, a wired network, a wireless network, a telephony network, and so on.

Upon the playback device 116 receiving indication that the received video file 102 is to be played back, as indicated by the arrow 408, the playback device 116 determines an identity or identifier of the video file 102, and submits this identifier 404 to the playback settings server 402 over the network 406, as indicated by the arrow 410. In response, the playback settings server 402 sends the playback settings file 108 for the video file 102 to the playback device 116 over the network 406, as corresponding to the identifier 404 and as indicated by the arrow 412. Thereafter, the playback device 116 plays back the video file 102 on the display device 112 using the playback settings file 108, as has been described, and is indicated by the arrow 414. Besides the identifier 404 of the video file 102, the playback device 116 may also send an identity or identifier 405 of the display device 112, as indicated by the arrow 411, in the embodiment where the playback settings file 108 is specific to a particular type of the display device 112 in addition to being for a particular video file 102, and/or to other parameters of the display device 112.

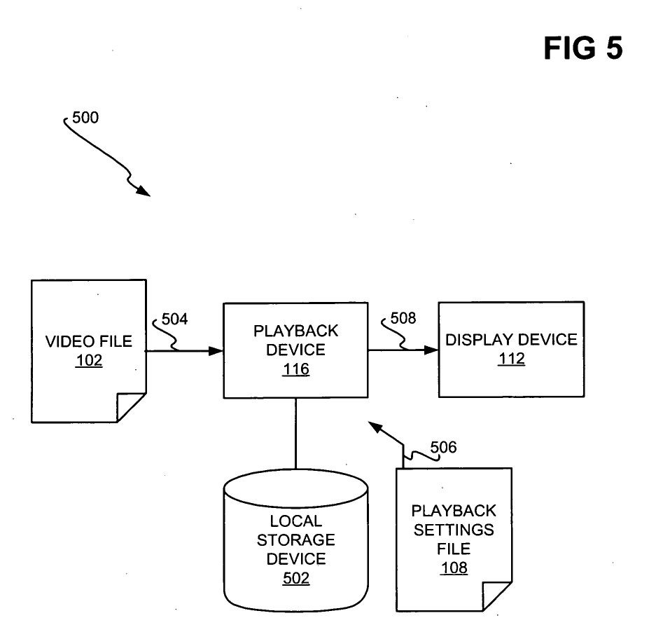

FIG. 5 shows a system 500 depicting the manner by which the playback device 116 is able to acquire the playback settings file 108 for a particular video file 102, according to another embodiment of the invention. The playback settings file 108 for the video file 102 is generated in time before playback of the video file 102 by the playback device 116, and is stored at a storage device 502 that is local to the playback device 116. For example, the storage device 502 may be a hard disk drive that is internal or external to the playback device 116, and may in one embodiment be a network-attached storage (NAS) device.

The playback settings file 108 may have been previously generated by the playback device 116 and stored on the storage device 502. In another embodiment, the playback settings file 108 may have been generated by a different device, other than the playback device 116, and received by the playback device 116 for storage on the storage device 502. For example, the playback device 116 may receive the playback settings file 108 for the video file 102 from over a network for storage on the storage device 502. As another example, the playback device 116 may receive the playback settings file 108 on the same physical computer-readable medium as it has received the video file 102, such as a DVD.

Playback of the received video file 102 is requested, as indicated by the arrow 504. The playback device 116 in response retrieves the playback settings file 108 for the video file 102, as indicated by the arrow 506. The playback device 116 plays back the video file 102 using the playback settings file 108 for display on the display device 112, as has been described, and as indicated by the arrow 508.

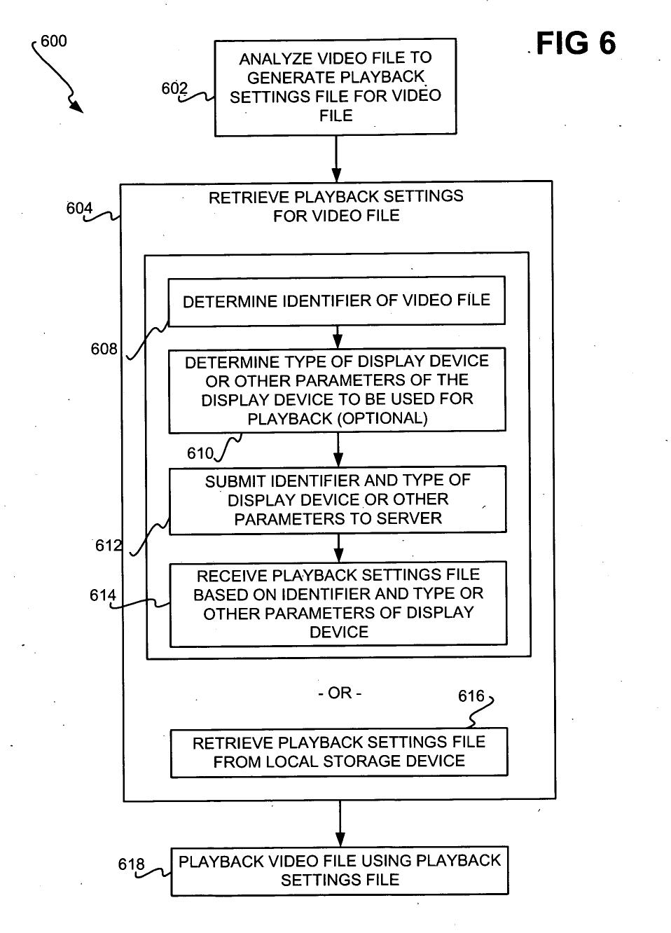

FIG. 6 shows a method 600 for using the previously generated playback settings file 108 when playing back the video file 102, according to an embodiment of the invention. At least some parts of the method 600 may be implemented as computer program parts, such as module, objects, subroutines, and the like, of a computer program stored on a computer-readable medium. The medium may be a volatile or a non-volatile medium, such as a magnetic medium, a semiconductor medium, and/or an optical computer-readable medium.

The video file 102 is first analyzed, or processed, to generate the playback settings file 108 for the video file 102 (602). The playback settings file 108 may be generated further based on the particular type of display device 112 used for playing back the video file 102, and/or other parameters regarding the display device 112. Analysis of the video file 102 to generate the playback settings file 108 does not result in modification or alteration of the video file 102. The analysis may occur with or without user interaction, and may be performed with one or more passes of the video file 102, as has been described. Furthermore, analysis may be performed on the same or a different device than the device at which playback of the video file 102 is to ultimately occur.

The playback settings file 108 for the video file 102 is retrieved (604). Such retrieval may be accomplished in differing embodiments by performing 608, 610, 612, and 614, or by performing 616. In 608, an identifier of the video file 102 is determined that at least substantially uniquely identifies the video file 102. The type of display device 112 that is to be used for playing back the video file 102, and/or other parameters of the display device 112, may also optionally be determined (610). The identifier of the video file 102, and optionally the type of display device 112 or other parameters regarding the device 112, are submitted to the playback settings server 402 of FIG. 4 (612), which returns the playback settings file based on the identifier of the video file 102 and also optionally on the type or other parameters of the display device 112 (614). Alternatively, the playback settings file 108 may be retrieved from the local storage device 502 of FIG. 5 (616).

The video file 102 is played back using the playback settings file 108 that has been retrieved (618). Playback of the video file 102 may be accomplished without having to perform any real-time analysis of the video file 102 to determine the playback settings present in the file 108, since the settings can be simply read from the file 108. The playback settings may include deinterlacing settings, video noise reduction settings, color adjustment settings, brightness adjustment settings, scaling settings, and the like, on either a frame-by-frame or a group of frames-by-group of frames basis.

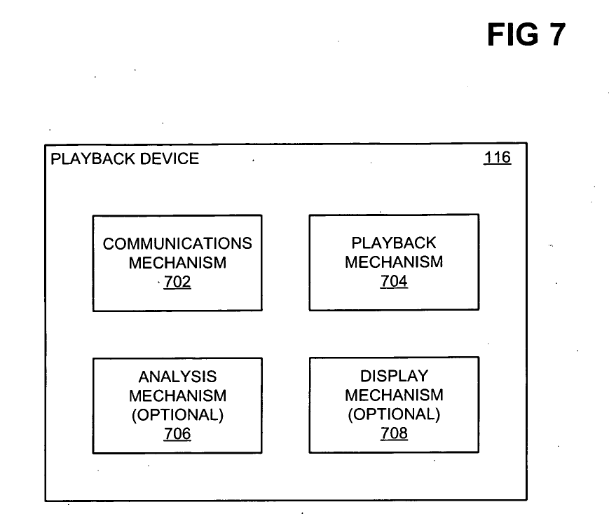

FIG. 7 is a rudimentary diagram of the playback device 116 that has been described, according to an embodiment of the invention. The playback device 116 includes a communications mechanism 702 and a playback mechanism 704, and optionally an analysis mechanism 706 and a display mechanism 708. Each of the mechanisms 702, 704, 706, and 708 may be implemented in software, hardware, or a combination of hardware and software. The playback device 116 may further include other mechanisms, in addition to and/or in lieu of those depicted in FIG. 7, as can be appreciated by those of ordinary skill within the art.

The communications mechanism 702 retrieves the playback settings file 108 for the video file 102 to be played back on the playback device 116. The communications mechanism as such may include or be a network communications mechanism, such as a network adapter, to retrieve the playback settings file 108 from a server over a network, as has been described in relation to FIG. 4. The communications mechanism also may include or be a local storage device, such as a hard disk drive, on which the playback settings file 108 has been stored, as has been described in relation to FIG. 5.

The playback mechanism 704 plays back the video file 102 in accordance with the playback settings of the playback settings file 108. The analysis mechanism 706, when present, processes or analyzes the video file 102 to generate the playback settings file 108. The display mechanism 708, when present, is that on which the playback mechanism 704 is to display the video file 102 during playback in accordance with the playback settings file 108. The display mechanism 708 may be or include a display device. Alternatively, such a display device may not be part of the playback device 116 itself. The playback settings file 108 may be generated based on the particular type or other parameters of the display mechanism 708.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
retrieving a playback settings file for a video file, the playback settings file previously generated based at least on analysis of the video file without alteration of the video file, the playback settings file containing information for playback of the video file other than information for decoding the video file; and,
playing back the video file in accordance with the playback settings file.

2. The method of claim 1, wherein the video file is played back on a particular type of display device, the playback settings file having been previously generated further based on the particular type of display device.

3. The method of claim 1, further comprising initially processing the video file to generate the playback settings file, such that the video file remains unaltered.

4. The method of claim 3, wherein the video file is processed without involvement of a user.

5. The method of claim 3, wherein the video file is processed with involvement of a user.

6. The method of claim 3, wherein the video file is processed over a plurality of complete passes over the video file.

7. The method of claim 3, wherein processing the video file is accomplished at a device other than a device at which playback of the video file is to be accomplished.

8. The method of claim 3, wherein processing the video file is accomplished at a same device at which playback of the video file is to be accomplished.

9. The method of claim 1, wherein the playback settings file provides playback settings for the video file on at least substantially a frame-by-frame basis, such that the playing back the video file in accordance with the playback settings file comprises using the playback settings for the video file for playing back at least substantially each of a plurality of frames of the video file.

10. The method of claim 9, wherein the playback settings of the playback settings file comprises at least one of: deinterlacing settings, video noise reduction settings, color adjustment settings, brightness adjustment settings, and scaling settings.

11. The method of claim 1, wherein the playback settings file provides playback settings for the video file on at least substantially a group of frames-by-group of frames basis.

12. The method of claim 1, wherein retrieving the playback settings file comprises retrieving the playback settings file over a network based on an identifier of the video file.

13. The method of claim 12, wherein retrieving the playback settings file over the network based on the identified of the video file comprises:
determining the identifier of the video file;
submitting the identifier of the video file to a playback settings device over the network; and,
receiving from the playback settings file device the playback settings file for the video file.

14. The method of claim 12, wherein retrieving the playback settings file over the network based on the identified of the video file comprises:
determining the identifier of the video file;
determining one or more parameters of a display device on which the video file is to be displayed;
transmitting the identifier of the video file and the parameters of the display device to a playback settings file device over the network; and,
receiving from the playback settings file device the playback settings file for the video file, as particular to the parameters of the display device on which the video file is to be displayed.

15. The method of claim 1, wherein retrieving the playback settings file comprises retrieving the playback settings file from a local storage device storing the playback settings file.

16. A playback device comprising:
a communications mechanism to retrieve a playback settings file for a video file to be played back on the playback device, the playback settings file containing information for playback of the video file other than information for decoding the video file; and,
a playback mechanism to playback the video file for display in accordance with the playback settings file,
wherein the playback settings file has been generated prior to playback of the video file based at least on previous analysis of the video file without alteration of the video file.

17. The playback device of claim 16, further comprising a display mechanism on which the playback mechanism is to display the video file as played back in accordance with the playback settings file, wherein the playback settings file has been previously generated further based on one or more parameters of the display mechanism to be used to display the video file.

18. The playback device of claim 16, further comprising an analysis mechanism to process the video file in non-real time to generate the playback settings file.

19. The playback device of claim 18, further comprising a display mechanism on which the playback mechanism is to display the video file as played back in accordance with the playback settings file, wherein the analysis mechanism is to generate the playback settings file further based on one or more parameters of the display mechanism.

20. The playback device of claim 16, wherein the communications mechanism comprises a network communications mechanism to retrieve the playback settings file for the video file from over a network, the playback settings file having been generated at a device other than the playback device.

21. The playback device of claim 16, wherein the communications mechanism comprises a storage device locally storing the playback settings file.

22. The playback device of claim 16, wherein the playback mechanism is to play back the video file such that no real-time analysis of the video file occurs during playback for determining playback settings for the video file.

23. The playback device of claim 16, wherein the video file and the playback settings file are stored on a same computer-readable medium.

24. The playback device of claim 16, wherein the playback settings file provides playback settings for the video file on at least substantially a frame-by-frame basis.

25. The playback device of claim 24, wherein the playback settings of the playback settings file comprises at least one of: deinterlacing settings, video noise reduction settings, color adjustment settings, brightness adjustment settings, and scaling settings.

26. A playback device comprising:
means for retrieving a playback settings file for a video file to be played back on the playback device, the playback settings file having been previously generated based at least on non-real time analysis of the video file without alteration of the video file; and,
means for playing back the video file for display in accordance with the playback settings file, the playback settings file containing information for playback of the video file other than information for decoding the video file.

27. The playback device of claim 26, further comprising means for displaying the video file, wherein the playback settings file has been previously generated further based on one or more parameters of the means for displaying the video file.

28. The playback device of claim 26, further comprising means for processing the video file in non-real time to generate the playback settings file.

29. The playback device of claim 28, wherein the means for processing the video file is to generate the playback settings file further based on one or more parameters of a display device on which the video file is to be displayed.

30. The playback device of claim 26, wherein the means for playing back the video file performs no real-time analysis of the video file during playback for determining playback settings for the video file.

31. A computer-readable medium having a computer program stored thereon, the computer program comprising:
a first computer program part to retrieve a playback settings file for a video file; and,
a second computer program part to play back the video file in accordance with the playback settings file,
wherein the playback settings file has been previously generated based at least on analysis of the video file without alteration of the video file.

32. The computer-readable medium of claim 31, wherein the playback settings file has been previously generated further based on one or more parameters of a display device on which the second computer program part is to play back the video file for display.

33. The computer-readable medium of claim 31, further comprising a third computer program part to process the video file in non-real time to generate the playback settings file.

34. The computer-readable medium of claim 33, wherein the third computer program part is further to generate the playback settings file based on one or more parameters of a display device on which the second computer program part is to play back the video file.

35. The computer-readable medium of claim 31, wherein the playback settings file provides playback settings for the video file on at least substantially a frame-by-frame basis, the playback settings of the playback settings file comprising at least one of: deinterlacing settings, video noise reduction settings, color adjustment settings, brightness adjustment settings, and scaling settings.
